(19) United States
(12) Patent Application Publication
(10) Pub. No.: US 2015/0025721 A1
(43) Pub. Date: Jan. 22, 2015

(54) HYBRID VEHICLE ENGINE WARM-UP

(71) Applicant: FORD GLOBAL TECHNOLOGIES, LLC, Dearborn, MI (US)

(72) Inventors: Scott James Thompson, Waterford, MI (US); Paul Stephen Bryan, Belleville, MI (US); Shunsuke Okubo, Belleville, MI (US); Elaine Y. Chen, Dearborn, MI (US)

(21) Appl. No.: 13/942,894

(22) Filed: Jul. 16, 2013

(51) Int. Cl. B60W 10/06; B60W 10/26

(52) U.S. Cl. CPC B60W 10/06; B60W 10/26; B60W 2510/244; B60W 2510/0676
USPC 701/22

(57) ABSTRACT

A hybrid powertrain system includes an engine, an electric machine, a battery pack, and at least one controller. If the controller detects that a temperature associated with the engine is less than a predefined value, it may request power output by the engine to increase such that the temperature increases to a threshold temperature if a state of charge of the battery pack is less than one hundred percent.

### TECHNICAL FIELD

This disclosure relates to controlling engine warm-up in a hybrid vehicle.

### BACKGROUND

Modern hybrid and electric vehicles utilize an internal combustible engine to provide energy for propulsion. Internal combustible engines in hybrid vehicles are typically controlled based on a number of powertrain characteristics to determine fuel efficiency and performance. A powertrain control system may determine suitable power combinations of an internal combustion engine and an electric motor to minimum energy use. The internal combustible engine may start when the battery pack has a low state of charge (SOC) and during certain vehicle driving modes to provide energy to the powertrain system. Once the internal combustible engine has started, the powertrain system control may demand the engine to stay on until engine coolant temperature, catalyst converter temperature and oil temperature reach a certain temperature level.

### SUMMARY

In a first illustrative embodiment, a hybrid powertrain system may include, but is not limited to, an engine, an electric machine, a battery pack, and at least one controller. The hybrid powertrain system may program the controller to respond to the engine being requested to turn on and monitor one or more temperature sensors associated with the powertrain system. If the controller detects that the one or more temperature sensors are less than a predefined value, the controller may request power output by the engine to increase such that the temperature increases to a threshold temperature. The controller may request an increase in power output of the engine if a driver power demand is greater than, less than, or equal to zero, and a state of charge of the battery pack is less than one hundred percent.

In a second illustrative embodiment, a hybrid powertrain system may include, but is not limited to, an engine, an electric machine, a battery pack, and at least one controller. The hybrid powertrain system may program the controller to respond to the engine being requested to turn on and a temperature associated with the engine being less than a predefined value. If the controller detects that the temperature associated with the engine is less than the predefined value, the controller may cause fuel consumption of the engine to increase such that the temperature increases to a threshold temperature. The controller may request an increase in fuel consumption of the engine if driver power demand is greater than zero and a state of charge of the battery pack is less than one hundred percent.

In a third illustrative embodiment, a powertrain warm-up method commanding higher engine power than requested may improve engine efficiency while reducing fuel consumption during a drive cycle. The method may respond to an engine being requested to turn on and a temperature associated with the engine being less than a predefined value. The method may command an increase in power output by the engine such that the temperature increases to a predefined value. The method may command an increase in power output by the engine to a predefined value if the system determines a state of charge of a battery pack is less than one hundred percent. The method commanding an increase in power output by the engine to a predefined value may be based on the state of charge to increase the temperature to a threshold value.

### BRIEF DESCRIPTION OF THE DRAWINGS

FIG. 1 is a diagram of a hybrid-electric vehicle illustrating typical drivetrain and energy storage components;

FIG. 2 is a diagram of a possible battery pack arrangement comprised of multiple cells, and monitored and controlled by a battery control module;

FIG. 3 is an example of powertrain system variables in communication with a vehicle-based computing system;

FIG. 4 is a flow chart illustrating an example algorithm for increasing engine power to improve warm-up;

FIG. 5 is a graph illustrating an example method of controlling engine power to improve powertrain warm-up; and

FIG. 6 is a graph illustrating a method of controlling an engine in a hybrid powertrain system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

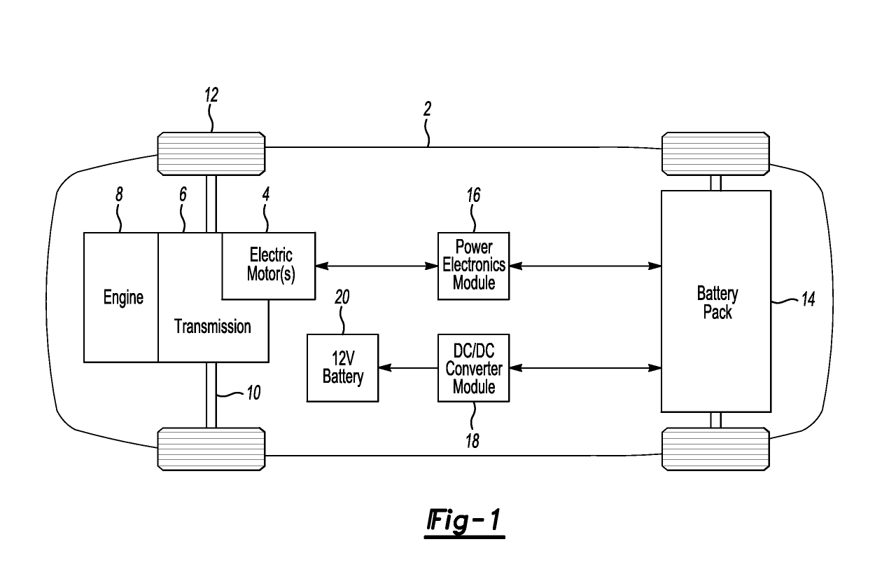

FIG. 1 depicts a typical hybrid-electric vehicle. A typical hybrid-electric vehicle 2 may comprise one or more electric motors 4 mechanically connected to a hybrid transmission 6. In addition, the hybrid transmission 6 is mechanically connected to an engine 8. The hybrid transmission 6 is also mechanically connected to a drive shaft 10 that is mechanically connected to the wheels 12. The electric motors 4 can provide propulsion and deceleration capability when the engine 8 is turned on or off. The electric motors 4 also act as generators and can provide fuel economy benefits by recovering energy that would normally be lost as heat in the friction braking system. The electric motors 4 may also provide reduced pollutant emissions since the hybrid electric vehicle 2 may be operated in electric mode under certain conditions.

The battery pack 14 stores energy that can be used by the electric motors 4. A vehicle battery pack 14 typically provides a high voltage DC output. The battery pack 14 is electrically connected to the power electronics module 16. The power electronics module 16 is also electrically connected to the electric motors 4 and provides the ability to bi-directionally transfer energy between the battery pack 14 and the electric motors 4. For example, a typical battery pack 14 may provide a DC voltage while the electric motors 4 may require a three-phase AC current to function. The power electronics module 16 may convert the DC voltage to a three-phase AC current as required by the electric motors 4. In a regenerative mode, the power electronics module 16 will convert the three-phase AC current from the electric motors 4 acting as generators to the DC voltage required by the battery pack 14. The method described herein is equally applicable to a pure electric vehicle or any other device using a battery pack.

In addition to providing energy for propulsion, the battery pack 14 may provide energy for other vehicle electrical systems. A typical system may include a DC/DC converter module 18 that converts the high voltage DC output of the battery pack 14 to a low voltage DC supply that is compatible with other vehicle loads. Other high voltage loads may be connected directly without the use of a DC/DC converter module 18. In a typical vehicle, the low voltage systems are electrically connected to a 12V battery 20.

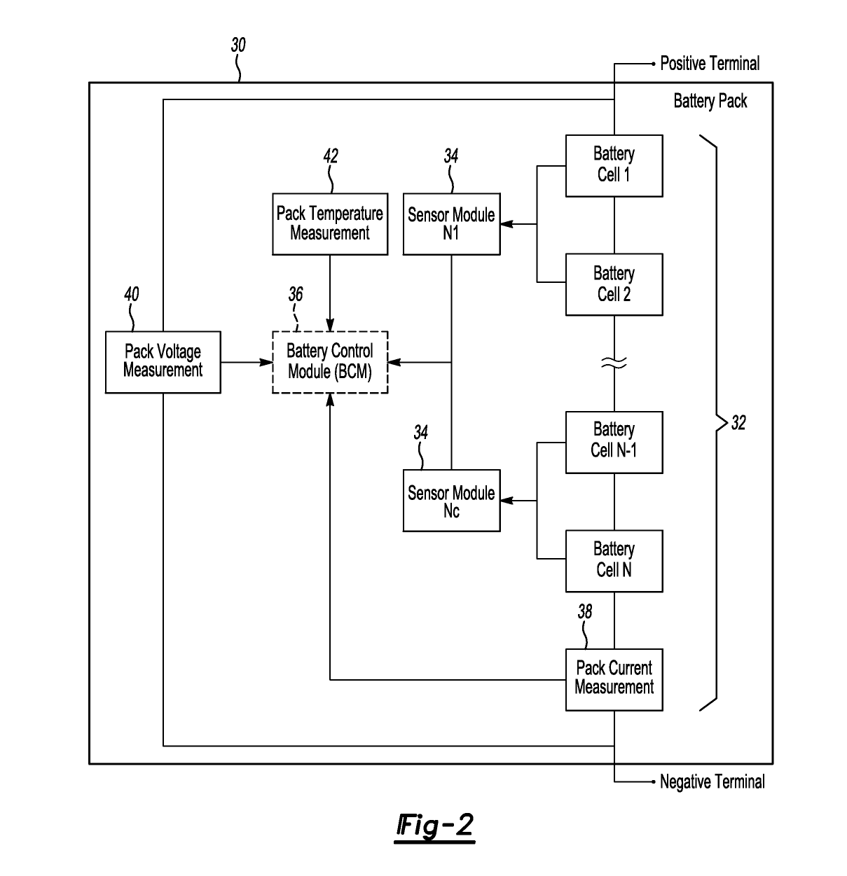

Battery packs may be constructed from a variety of chemical formulations. Typical battery pack chemistries are lead acid, nickel-metal hydride (NIMH) or Lithium-Ion. FIG. 2 shows a typical battery pack 30 in a simple series configuration of N battery cells 32. Other battery packs, however, may be composed of any number of individual battery cells connected in series or parallel or some combination thereof. A typical system may have a one or more controllers, such as a Battery Control Module (BCM) 36 that monitors and controls the performance of the battery pack 30. The BCM 36 may monitor several battery pack level characteristics such as pack current 38, pack voltage 40 and pack temperature 42.

In addition to the pack level characteristics, there may be battery cell level characteristics that need to be measured and monitored. For example, the terminal voltage, current, and temperature of each cell may be measured. A system may use a sensor module 34 to measure the battery cell characteristics. Depending on the capabilities, the sensor module 34 may measure the characteristics of one or multiple of the battery cells 32. The battery pack 30 may utilize up to N_{c} sensor modules 34 to measure the characteristics of all the battery cells 32. Each sensor module 34 may transfer the measurements to the BCM 36 for further processing and coordination. The sensor module 34 may transfer signals in analog or digital form to the BCM 36.

An important measure of the battery system may be the SOC of the battery pack. Battery pack SOC gives an indication of how much charge remains in the battery pack. The battery pack SOC may be output to inform the driver of how much charge remains in the battery pack, similar to a fuel gauge. The battery pack SOC may also be used to control the operation of an electric or hybrid-electric vehicle. Calculation of battery pack SOC can be accomplished by a variety of methods.

Some modern SOC estimation methods use model-based methods, such as Kalman filtering, to determine a more accurate SOC. A model-based method works by using a model of the battery cell and then predicting the internal states of the battery cell based on some actual measured values. Estimated internal states may include, but are not limited to, voltages, currents, or SOC. A typical approach is to apply a Kalman filter to each cell of the battery pack and then use these cell values for calculating the overall pack characteristics. This requires the controller to execute a number of Kalman filters that is equal to the number of cells present in the battery pack. The number of cells in a battery pack varies, but a modern vehicle battery pack may consist of 80 or more cells.

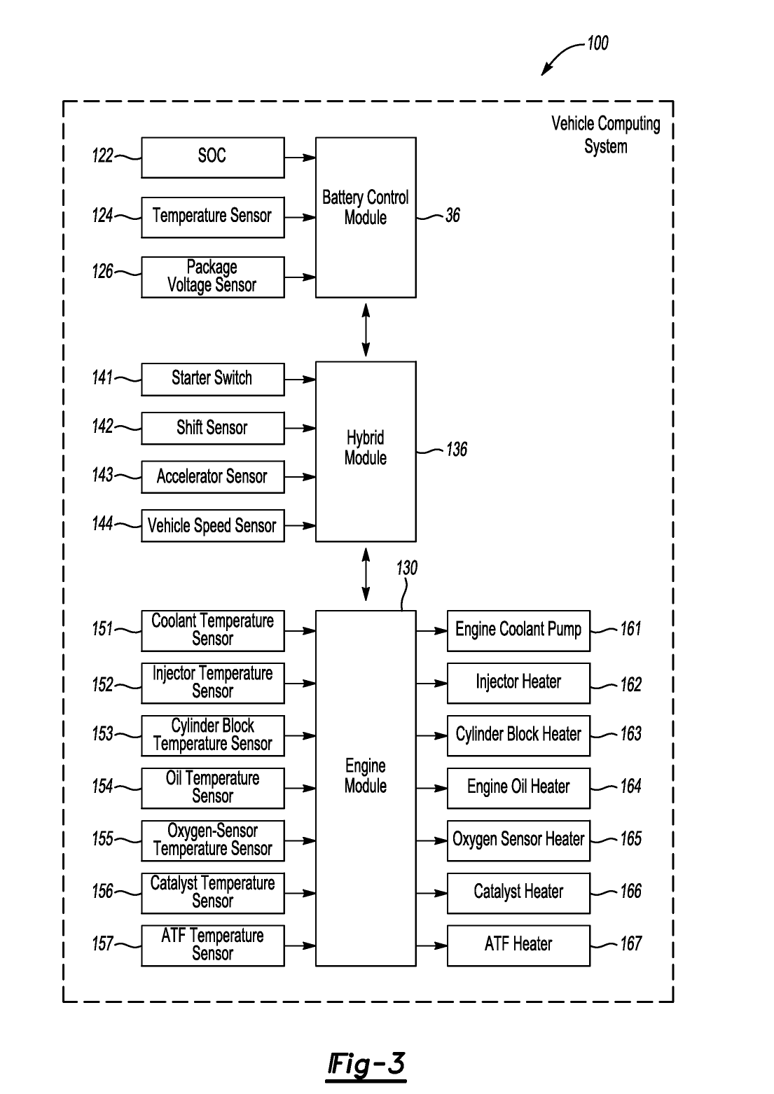

FIG. 3 is an example of powertrain variables in a hybrid vehicle that are in communication with a vehicle based computing system. The powertrain variables may be used to determine control of the internal combustion engine management strategy in a hybrid vehicle computing system 100. The engine management strategy may allow increased engine efficiencies by controlling the internal combustion engine based on the monitoring of one or more system module variables including, but not limited to, battery module, hybrid module, and engine module. The numerous vehicle components, sensors, systems, and auxiliary components in communication with the vehicle computing system may use a vehicle network (such as, but not limited to, a CAN bus) to pass data to and from the vehicle computing system (or components thereof).

The engine may include, but is not limited to, a coolant temperature sensor 151, a heat accumulator, a coolant pump 161, a cylinder block temperature sensor 153, a cylinder head temperature sensor and a cylinder block heater 163. The coolant temperature sensor 151 detects a temperature of coolant in the engine. The coolant pump 161 may send coolant maintained at a certain high temperature from the heat accumulator 128 into the engine. The cylinder block temperature sensor 153 detects a temperature of a cylinder block. The cylinder block may have a cylinder block heater 163 that is mounted to the cylinder block. The cylinder temperature sensor detects a temperature of a cylinder head. By sending coolant maintained at a certain high temperature into the engine when the temperature of the engine is low or heating the cylinder block and/or cylinder head, the engine is suitably warmed. Further, the engine may include an injector temperature sensor 152 for detecting temperatures of injectors for injecting gasoline, and an injector heater 162 capable of heating the injectors. By heating the injectors up to a predetermined temperature or to a temperature higher than the predetermined temperature when the temperature of the engine is low, fuel injected from the injectors can be suitably atomized.

The engine has an oil pan containing engine oil for providing lubricant to components throughout the engine system. The oil pan is designed such that engine oil is supplied from the oil pan to spaces among parts that are mechanically in contact with one another in the engine, and that the engine oil returns to the oil pan again. Installed in this oil pan is an oil temperature sensor 154 for detecting a temperature of engine oil. Some engines may have an engine oil heater 164 capable of heating engine oil. At a predetermined temperature, engine oil exhibits an appropriate viscosity and exerts good lubricating performance without offering considerable resistance.

The powertrain system may have an oxygen-sensor temperature sensor 155 for detecting a temperature of an oxygen sensor. Some powertrain system may have an oxygen sensor heater 165 capable of heating the oxygen sensor that may be disposed in an exhaust passage of the engine. The oxygen sensor detects a concentration of oxygen contained in exhaust gas for the purpose of A/F (air-fuel ratio) feedback control, and the output characteristic of the oxygen sensor stabilizes at a relatively high temperature (e.g., 400 to 900° C.).

In addition, a powertrain system may have a catalyst temperature sensor 156 for detecting a temperature of a catalytic converter for purifying exhaust gas. In some powertrain systems, they may include a catalyst heater 166 capable of heating the catalytic converter that is disposed in this exhaust passage of the engine. The catalytic converter exerts purification performance at a predetermined temperature (e.g., 350° C.) or at a temperature higher than the predetermined temperature.

The electric motor and/or the generator in the hybrid vehicle may be controlled by one or more control modules including the engine control module 130, and the hybrid control module 136. The engine control module may be in communication with the hybrid control module such that control of the powertrain system is transferred between the two modules. In response to a command signal delivered from the hybrid module 136, signals (rotation speed, applied voltage, and the like) necessary for operationally controlling the motor 4 and the generator 4 are input to the power electronics module therefrom. Then, the power electronics module outputs a switching control signal to the inverter.

Although not shown, a vehicle computing system may control several hybrid powertrain system configurations including, but not limited to, electric, flywheel, hydraulic, or step ratio transmissions. For example, a hybrid powertrain system configuration controlled by the vehicle computing system is the power-splitting mechanism having a planetary gear composed of a ring gear coupled to a rotational shaft of the motor 4, a sun gear coupled to a rotational shaft of the generator 4, and a carrier coupled to an output shaft of the engine 8. The power-splitting mechanism splits power of the engine 8 into power for the rotational shaft of the motor (linked with the driving wheels W) and power for the rotational shaft of the generator. In another embodiment, the power-splitting mechanism only connects the engine to power the rotational shaft of the generator to only charge the battery system in a hybrid electric vehicle.

The battery 14 is a high-voltage battery constructed by connecting a predetermined number of nickel-hydrogen battery cells in series. The battery 14 supplies the motor 4 with accumulated power, or is charged with power generated by the motor or the generator. The battery 14 is managed by a battery module 36. The battery module 36 is connected to the hybrid module such that communication between them is possible. The battery system may include, but is not limited to, a state of charge/health sensor 122, a temperature sensor 124, and package voltage sensor 126. The one or more sensor in the battery system may communicate with the battery control module 36.

The inverter is a power exchange unit that exchanges direct current of the battery 14 and alternating current of the motor and/or the generator with each other by means of a motor bridge circuit and a generator bridge circuit. Each of the motor bridge circuit and the generator bridge circuit may be composed of six power transistors. The inverter may be controlled by the power electronics module.

The transmission 6 is a mechanism that transmits power of the power-splitting mechanism for the side of the driving wheels 12 to the driving wheels 12 via a differential portion, and is designed such that automatic transmission fluid (ATF) for lubrication circulates inside the transmission 6. An ATF temperature sensor 157 may be used for detecting a temperature of ATF and in some powertrain system configurations may include an ATF heater 167 capable of heating ATF to a desired temperature level.

Signals are input to the hybrid module 136 from a starter switch 141 for detecting rotation of a key to a starter position, a shift sensor 142 for detecting an operational position of a shift lever, an accelerator sensor 143 for detecting a depression stroke of an accelerator pedal, a vehicle speed sensor 144 for detecting a current running speed of the vehicle, and a variety of other sensors (not shown). Further as shown in FIG. 1, the hybrid-electric vehicle powertrain system includes the engine, the motor, and the battery. In response to input signals delivered from the sensors of each of these systems, the one or more control modules in communication with each other perform hybrid control such that the vehicle runs using at least one of the engine and/or the electric motor as a power source, while communicating with the engine, hybrid and battery modules.

In one example, in a range of low engine efficiency and an acceptable SOC of the battery system, when the vehicle starts or runs at a low speed the vehicle computing system may stop the engine and request the battery system to control the powertrain such that the vehicle runs with the driving wheels being driven by power of the electric motor. On the other hand, when the vehicle runs normally, the vehicle computing system operates the engine, splits power of the engine into power for the driving wheels and power for the generator by means of the power-splitting mechanism, causing the generator to generate power, operates the motor by the power generated by the generator, and performs control in such a manner as to assist the driving of the driving wheels. In addition, when the vehicle runs with a high load, for example, when the vehicle is accelerated with the accelerator being fully open, the motor is supplied with power from the battery as well, so that an additional operating force is obtained. While the vehicle is stopped running, the vehicle computing system performs control so as to stop the engine.

A typical hybrid vehicle powertrain system may be calibrated to offset the consumption of fuel while minimizing the internal combustible engine use by requesting the battery system to power the electric motors during a majority of the driving maneuvers. If the engine is requested by the hybrid vehicle powertrain system while the battery state of charge is at an acceptable level, the powertrain system may request a low engine power command (e.g., idle) to minimize fuel consumption. The hybrid vehicle powertrain system operating strategy may cause the engine to run under low power conditions for a longer period of time. Under certain conditions during cold starts or when the engine is not warmed up to an acceptable level, the operating strategy may cause poor drivability, unacceptable powertrain performance, and/or improper vehicle cabin climate control (e.g., Heating, Ventilation, and Air-Conditioning system, more specific heater performance).

For example, a plug-in hybrid vehicle may have a powertrain strategy to run the internal combustible engine at a much lower power state to minimize the use of fuel while depleting the battery state of charge by allowing the electric motor to power the majority of the driver requested acceleration. Under this example the powertrain strategy may request the engine to run at an idle state, while the battery system discharges as much as possible to reduce fuel consumption. The strategy may have a goal of reducing fuel consumption by allowing the engine to run at a low power level; however the strategy lacks energy efficiency by allowing the engine to run for longer periods of time by trying to warm-up the various engine components before allowing engine shutoff.

The plug-in hybrid powertrain strategy may have to run the engine for a longer period of time to achieve engine warm-up before allowing the engine to shutoff so that the vehicle can run completely off the battery system power. This strategy may seem like it is reducing fuel consumption. It, however, may be found that based on the length of time, powertrain performance, and poor drivability, this strategy may be inefficient.

In another example, a non-plug-in hybrid vehicle powertrain system may drive the engine to run until the various engine components are warmed up before allowing the battery system to power the driver requested acceleration. In the non-plug-in hybrid vehicle, the system may determine one or more calibratable points to run the engine before allowing engine shutoff in a hybrid mode.

Instead of running the internal combustible engine at low levels for longer periods of time, the hybrid powertrain system may, based one or more variables, demand more engine power therefore increasing fuel consumption for swifter engine warm-up for a calibrated period of time while improving drivability, powertrain performance, fuel economy, and in-vehicle climate control. By allowing the engine to warm-up faster in a hybrid vehicle, the powertrain system may drive the engine toward an efficiency point to burn more fuel than it otherwise would—causing the engine to warm-up properly allowing more engine off capability. The faster warm-up of the powertrain system may reduce the amount of time the engine is on to warm-up the one or more components, therefore improving fuel economy and powertrain performance for the drive cycle.

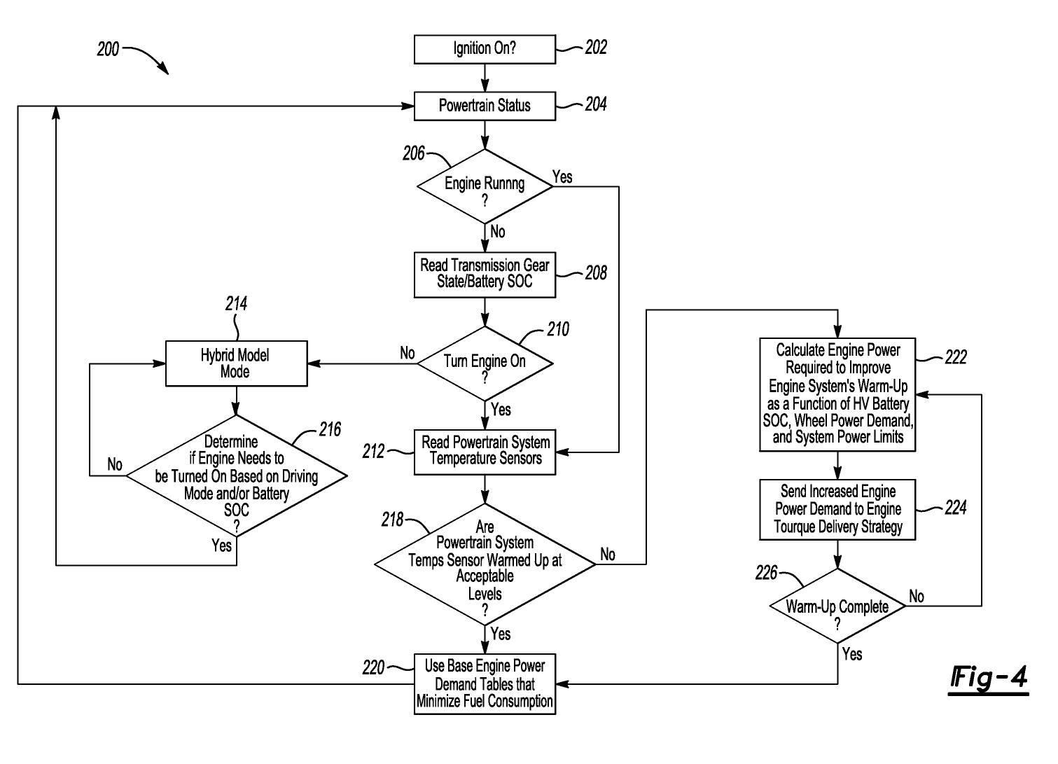

FIG. 4 is a flow chart illustrating an example method of increasing engine power to improve a hybrid vehicle warm-up. The method is implemented using software code contained within the vehicle control module, according to one or more embodiments. In other embodiments, the method 200 is implemented in other vehicle controllers, or distributed amongst multiple vehicle controllers.

Referring again to FIG. 4, the vehicle and its components illustrated in FIGS. 1-3 are referenced throughout the discussion of the method to facilitate understanding of various aspects of the present invention. The method of controlling engine warm-up in the vehicle may be implemented through a computer algorithm, machine executable code, or software instructions programmed into a suitable programmable logic device(s) of the vehicle, such as the vehicle control module, the hybrid control module, other controller in communication with the vehicle computing system, or a combination thereof. Although the various steps shown in the flowchart diagram 200 appear to occur in a chronological sequence, at least some of the steps may occur in a different order, and some steps may be performed concurrently or not at all.

The engine power management strategy of a hybrid vehicle may increase engine power if an engine warm-up is desired by the vehicle computing systems. An engine warm-up may be required for a variety of reasons including, but not limited to, engine protection, engine maintenance, engine efficiency, catalyst (CAT) light of, and temperature maintenance for climate heater performance. The one or more variables requesting an engine warm-up in a hybrid vehicle may cause the engine power to increase to a more efficient power level than having the engine remain at an idle condition for a longer period of time.

If the vehicle computing system receives a temperature reading measuring one or more variables (e.g., engine coolant) below a predefined, calibratable, or hardcoded value while the battery state of charge is at an acceptable level, then the vehicle computing system may demand an increase in engine power instead of remaining at an idle condition. The increase in engine power may be controlled or damped by the vehicle computing system depending on how the powerflow is used with the hybrid powertrain system.

The hybrid powertrain system may use the following equation to determine calculated engine power (P_{eng}) by the vehicle computing system:

P_{eng}=P_{wheel}_{_{—}}_{demand}−P_{battery}_{_{—}}_{desired}+Pₗₒₛₛ (1)

wherein P_{battery}_{_{—}}_{desired} is a table that is a function of battery state of charge and wheel power demand that may also be damped/clipped by the power that is available from the battery through the battery's reported power limits, P_{wheel}_{_{—}}_{demand} is the driver demand for requested wheel power, and Pₗₒₛₛ is the power loss associated with the mechanical components in the powertrain system. For the sake of simple math in this example, Pₗₒₛₛ will be considered zero. However in a powertrain system, there are many factors that may cause power loss to be a value greater than zero.

In a hybrid powertrain vehicle, the P_{battery}_{_{—}}_{desired} may be predefined based on a powertrain system using one or more calibratable tables. The tables may be based on the battery state of charge and the driver demand for wheel power. The one or more tables may be calibrated to control the powertrain system by requiring minimum fuel consumption from the engine.

TABLE 1

| | X | | | | | |
|---|---|---|---|---|---|---|
| Y | 0 | 6 | 15 | 35 | 40 | 60 |
| 35 | −4 | −4 | −3 | −3 | −3 | −3 |
| 50 | −4 | −4 | 0 | 0 | 0 | 15 |
| 65 | 0.5 | 0.5 | 1 | 5 | 9 | 17.5 |
| 70 | 0.5 | 1 | 5 | 13 | 23 | 48 |
| 90 | 0.5 | 1 | 5 | 13 | 23 | 48 |

A hybrid powertrain system may have at least one table to request a boost in engine power output to warm-up the one or more powertrain components. The boost in power out to warm-up the engine may increase engine efficiency and enable engine off capabilities more frequent during a drive cycle as shown in Table 1. The faster warm-up may allow the reduction of fuel consumption and improved powertrain performance during a drive cycle. The powertrain system may detect that one or more components are not at a predefined temperature level. Therefore, the system may follow Table 1 to improve the hybrid powertrain efficiency. In Table 1, the X-axis represents P_{wheel}_{_{—}}_{demand} which is the driver demand for requested wheel power. The Y-axis represents the state of charge of the battery system. If the driver demand for requested wheel power is at 35 kW and the state of charge is at 70 percent, the battery system may provide 13 kW of the requested wheel power allowing the engine to deliver the remaining 22 kW. The remaining 22 kW may allow the engine to perform an efficient warm-up. After a period of time and/or once the vehicle computing system detects that the predefined temperature parameters have been sustained—signifying that the powertrain system has been warmed-up—the hybrid system may follow a normal operation powertrain calibration table as shown in Table 2.

TABLE 2

| | X | | | | | |
|---|---|---|---|---|---|---|
| Y | 0 | 6 | 15 | 35 | 40 | 60 |
| 35 | −4 | −4 | −3 | −3 | −3 | −3 |
| 50 | −4 | −4 | 0 | 0 | 0 | 15 |
| 65 | 0.5 | 0.5 | 1 | 5 | 9 | 17.5 |
| 70 | 0.5 | 2 | 10 | 20 | 30 | 48 |
| 90 | 0.5 | 2 | 10 | 25 | 30 | 48 |

Once the powertrain system detects that the one or more components meet the predefined temperature levels, the system may follow Table 2 to control the hybrid powertrain strategy limiting the power being requested to the engine to decrease fuel consumption. In Table 2, the X-axis represents P_{wheel}_{_{—}}_{demand}, which is the driver demand for requested wheel power, and the Y-axis represents the state of charge of the battery system. If the driver demand for requested wheel power is at 35 kW and the state of charge is at 70 percent, the battery system may provide 25 kW of the requested wheel power allowing the engine to deliver the remaining 10 kW. This hybrid powertrain strategy reduces the use of the engine while the battery state of charge is high enough to produce a majority of the requested wheel power being commanded by the driver. It must be noted that one or more calibratable tables may demand that the engine shutoff and that the battery supply all of the driver demand for requested wheel power under several hybrid driving mode scenarios.

In another example, if the engine control module detects that the engine coolant level is below a predefined value and the wheel power requested by the driver is 20 kW, then the vehicle computing system may request the engine to run at 20 kW to improve engine warm-up. However, if the 20 kW is being requested by the driver and the engine warm-up is not required and/or needed based on the hybrid powertrain system, the vehicle computing system may request the engine to run at 5 kW and offset the remaining 15 kW of the power requested from the battery system commanding the one or more electric motors.

At step 202, the vehicle computing system may detect that the driver has entered the vehicle and has requested ignition on. Once the ignition is turned on, the system may determine the powertrain status at step 204. The powertrain status may include, but is not limited to, driver power command, state of charge of the battery, request of heat, ventilation, air condition and/or if the internal combustion engine is needed.

At step 206, the system may determine if the engine is being requested on or off. If the engine is not being requested by the powertrain system and is currently in an off state, the vehicle computing system may determine whether or not the engine will be turned on based on one or more variables including, but not limited to, a transmission gear state and battery state of charge at step 208.

At step 210, based on the one or more variables to predict driver power and battery state of charge, the powertrain system may request the engine to turn on. If the engine remains off, the vehicle may receive its power from the battery system at step 214. With the engine off, the powertrain system is able to drive the vehicle wheels based on the one or more electric motors. If the system determines that the engine needs to be turned on based on the driving mode, and/or battery state of charge, than the system may request to update the powertrain status at step 216.

At step 212, if the engine is being requested on, the powertrain system may measure the current system temperature using one or more sensors located on various components. The system may determine whether the temperature levels at the various components are at acceptable levels at step 218. The acceptable temperature levels at the various components may be a calibratable value based on component performance, powertrain system performance, drivability, and/or emission regulations.

At step 220, if each component temperature level is at an acceptable level based on the calibratable value it is compared to, the system may use base engine power demand tables that may minimize powertrain fuel consumption as illustrated in Table 2. For example, if the engine is being requested to turn on and the powertrain system temperature sensor indicates that the engine is warmed-up, the system may command engine power to be at a low power level (e.g., engine idle).

At step 222, if the powertrain system temperature sensors indicate that one or more components are not at an acceptable level, the engine power may be raised to improve the powertrain system warm-up. The powertrain system may calculate engine power to improve warm-up based on one or more variables including, but not limited to, battery state of charge, wheel power demand, and/or system power limits as illustrated in Table 1. The system may send the increased engine power demand to the engine creating a higher load to improve the system warm-up time at step 224.

At step 226, the system may monitor the temperature sensors to determine when the warm-up is complete. Once the powertrain system detects that the one or more component temperature sensor are at an acceptable level, the warm-up is complete and the engine power demand may be decreased to minimize fuel consumption.

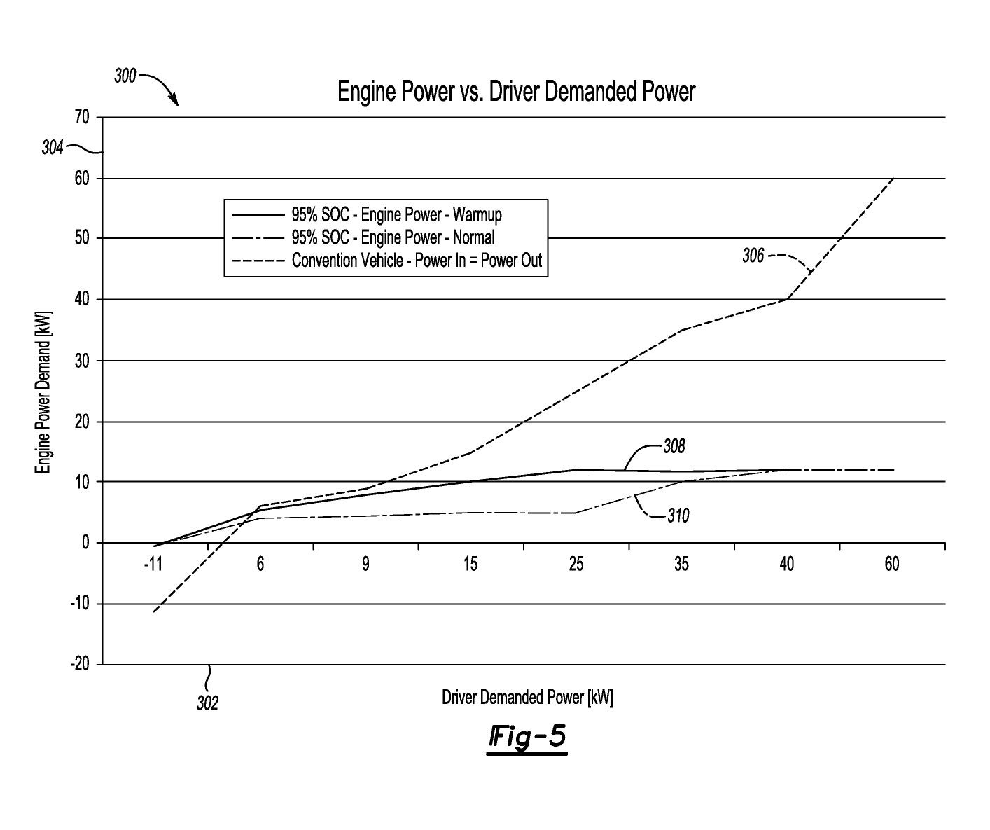

FIG. 5 is a graph illustrating an example method of controlling engine power to improve a hybrid powertrain warm-up. The graph represents the relationship between engine power and driver demanded power. The relationship between engine power and driver demanded power may have a different correlation depending on the configuration of the powertrain system.

The graph illustrates the driver demanded power 302 in kilowatts (kW) on the x-axis, and engine power demand 304 in kilowatts (kW) on the y-axis. The driver demanded power 302 may be a driver input that includes, but is not limited to, a driver requesting power by pushing on the accelerator pedal, setting cruise control, and/or shifting into a gear. The engine power demand 304 may be the vehicle computing system calculated power being requested to the powertrain system in response to the driver demanded power input. For example, if the driver demands 15 kW of power, the vehicle computing system may generate the corresponding engine power demanded to meet the driver's input request. In this example, the graph uses arbitrary numbers that do not represent all the mechanical losses that may be associated with a powertrain system.

The graph illustrates three types of engine power scenarios using a hybrid powertrain system and a non-hybrid powertrain system. The engine power scenarios include a conventional (non-hybrid) vehicle 306, a hybrid vehicle with a 95% state of charge using the warm-up strategy 308, and a hybrid vehicle with a 95% state of charge with a normal operation strategy 310. The state of charge percentage is an example number, and the warm-up strategy may be implemented on a range of state of charge values in a hybrid powertrain system.

For example, the conventional (non-hybrid) vehicle 306 may respond to a driver demanded power request by having the vehicle computing system command an engine power demand at almost a one to one ratio, again not accounting for powertrain mechanical losses. If the driver request is at 15 kW, the engine power demand may respond at 15 kW. The conventional vehicle powertrain system does not have a warm-up strategy to run the engine harder than the driver demanded power for a period of time to increase warm-up time for powertrain components including, but not limited to, engine oil, engine coolant, HVAC, and/or the catalytic converter.

In another example, the hybrid vehicle with a 95% state of charge having a normal engine operation strategy 310 may respond to a driver power request by having the vehicle computing system command a lower engine power demand allowing the battery system to mitigate the remaining power using the one or more electric motors. If the driver demanded power is requested at 15 kW then the vehicle computing system may transmit an engine power demand at 5 kW and a battery system request of the remaining 10 kW. The normal engine operation strategy may cause the engine to run for a long period of time before the one or more powertrain components are warmed up to an acceptable level.

In another example, the having a 95% state of charge using the warm-up strategy 308 may respond to a driver demanded power request by having the vehicle computing system command an engine power demand at a higher engine power if one or more powertrain variables indicates that the engine is not yet sufficiently warmed-up. If the driver demanded power is requested at 15 kW, then the vehicle computing system may transmit an engine power demand at 10 kW and a battery system request of the remaining 5 kW until the powertrain system is properly warmed-up. Once the powertrain system has been warmed up, the increased engine power demand in a hybrid vehicle may return to the normal engine operation strategy.

Applying the increased engine power demand for the engine warm-up strategy may require consumption of more fuel than a normal engine operation strategy. However once the engine has been warmed up, the hybrid powertrain system may reduce the use of the engine and allow more engine off capability. It may be believed that allowing the normal engine operation strategy to warm-up a powertrain system may reduce fuel consumption in a hybrid powertrain vehicle. However since the engine is running at a low level, the powertrain system may require a longer period of time to have the engine run to allow the powertrain components to warm-up. Using the engine warm-up strategy allows the engine to run more efficiently, increases engine off capability, and in return may reduce overall fuel consumption compared to a normal engine operation strategy.

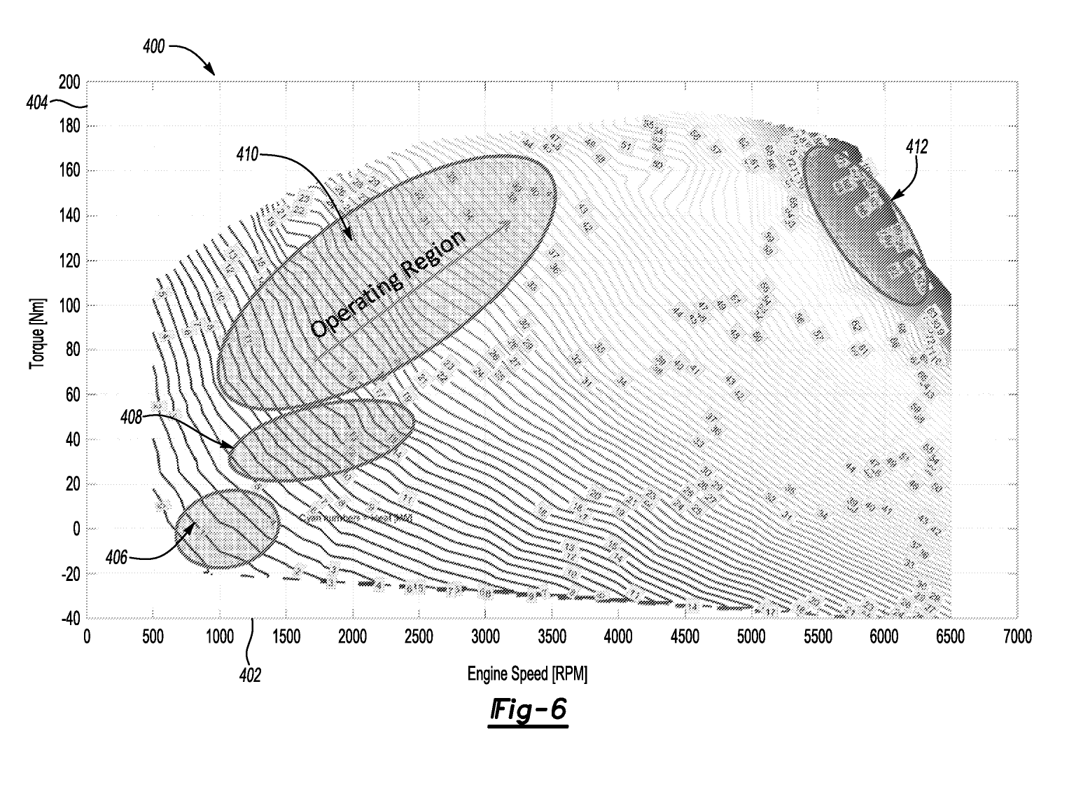

FIG. 6 is a graph illustrating a method of controlling an engine in a hybrid powertrain system. Using the one or more tables as illustrated in Table 1 and Table 2, a powertrain system may be calibrated to apply higher loads to the engine during hybrid modes to run at a brake specific fuel consumption point. The method of controlling the powertrain system to cause power out of the engine to increase may improve engine efficiency while reducing overall fuel consumption during a drive cycle. It may be based on consumer perception to reduce engine load during certain hybrid mode conditions. However based on the graph 400 illustrated in FIG. 6, the engine may be more efficient to run at higher loads for a period of time while reducing fuel consumption over the drive cycle.

The x-axis represents engine speed 402 in revolutions per minute, and the y-axis represents torque 404 in newton meters. The graph depicts regions where the engine may run more efficient during one or more hybrid modes based on engine speed and torque. A powertrain system may have an efficient operating region calibrated based on one or more system performance parameters during hybrid modes. The one or more system performance parameters may include, but is not limited to, battery state of charge, temperature of powertrain components, and/or environmental factors (e.g., road gradient, outside temperature, etc. . . . ).

For example, the typical operating region for a plug-in hybrid vehicle having a state of charge greater than or equal to a calibrated value (e.g., 70 percent) may have a low engine RPM operating region 406. The low engine RPM operating region may run when the powertrain components are not at their warm-up temperature settings causing inefficient engine operation. Running in the low engine RPM 406 operating region may cause the battery system to deplete its charge by requiring the electric motors to provide the majority of requested torque by the driver and/or system. When powertrain components are not at acceptable warm-up levels during the charge depletion mode, the engine is calibrated to a low engine RPM operating region causing inefficient fuel consumption, longer warm-up times for engine components, and/or unacceptable powertrain performance and drivability.

In another example, a hybrid vehicle may have a battery charge sustaining mode commanding the engine to an RPM operating region 408 greater than the low engine RPM. The hybrid vehicle may enter the battery charge sustaining mode based on the state of charge of the battery system. At this operating region, the engine may be at an inefficient engine operation at this mode if the powertrain system detects one or more components not at their warm-up temperature settings. When powertrain components are not at acceptable warm-up levels during the battery charge sustaining mode, the engine RPM operating region may cause inefficient fuel consumption, uneconomical battery charging, longer warm-up times for engine components, and/or unacceptable powertrain performance and drivability.

Another example of an inefficient operating region when a hybrid vehicle has a cold powertrain system and the battery state of charge is at an acceptable level to cause reduced fuel consumption may include an operating region 412 and control strategy of running the engine RPM at high RPM values. Running the engine too high to warm-up the powertrain system components may cause inefficient engine operation 412 and damage to one or more powertrain components.

An efficient operating region when one or more powertrain components are not at an acceptable warm-up level may be an operating region 410 in which the engine increases fuel consumption and engine RPMs are at greater levels based on torque requested. This operating region 410 allows the engine to run at brake specific fuel consumption points of the powertrain system. By allowing the engine to run at higher RPMs in a hybrid vehicle when the state of charge of the battery system is greater than or equal to a calibrated value (e.g., 85 percent) creates an opportunity of more frequent engine off capabilities during a drive cycle. For example, if the powertrain system requires more heat to warm-up components of the powertrain, the engine power request may follow the increase as represented by the arrow in the graph 400. This operating region 410 and calibrated strategy may be applied to several types of hybrid systems including, but not limited to, plug-in hybrid, mild hybrids, and full hybrid systems.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A hybrid powertrain system comprising:
an engine;
an electric machine;
a battery pack; and
at least one controller programmed to, in response to the engine being on and a temperature associated with the engine being less than a predefined value, cause power output by the engine to increase such that the temperature increases to a threshold temperature if driver power demand is greater than zero and a state of charge of the battery pack is less than one hundred percent.

2. The hybrid powertrain system of claim 1 wherein the at least one controller is further programmed to cause the power output by the engine to increase such that a brake specific fuel consumption of the engine increases.

3. The hybrid powertrain system of claim 1 wherein the at least one controller is further programmed to cause the power output by the engine to increase such that a brake specific fuel consumption of the engine decreases.

4. The hybrid powertrain system of claim 1 wherein the threshold temperature is a light off temperature for a catalytic converter associated with the engine.

5. The hybrid powertrain system of claim 1 wherein the temperature associated with the engine is a cylinder head temperature.

6. The hybrid powertrain system of claim 1 wherein the temperature associated with the engine is an engine coolant temperature.

7. The hybrid powertrain system of claim 1 wherein the at least one controller is further programmed to cause the power output by the engine to increase to a predefined value.

8. The hybrid powertrain system of claim 7 wherein the predefined value is based on the state of charge of the battery pack.

9. The hybrid powertrain system of claim 8 wherein the predefined value increases as the state of charge of the battery pack decreases.

10. A hybrid powertrain system comprising:
an engine;
an electric machine;
a battery pack; and
at least one controller programmed to, in response to the engine being on and a temperature associated with the engine being less than a predefined value, cause fuel consumption of the engine to increase such that the temperature increases to a threshold temperature if driver power demand is greater than zero and a state of charge of the battery pack is less than one hundred percent.

11. The hybrid powertrain system of claim 10 wherein the threshold temperature is a light off temperature for a catalytic converter associated with the engine.

12. The hybrid powertrain system of claim 10 wherein the temperature associated with the engine is a cylinder head temperature.

13. The hybrid powertrain system of claim 10 wherein the temperature associated with the engine is an engine coolant temperature.

14. A powertrain warm-up method comprising:
in response to an engine being on and a temperature associated with the engine being less than a predefined value, commanding an increase in power output by the engine to a predefined value based on the state of charge to increase the temperature to a threshold value.

15. The method of claim 14 wherein the threshold value is a light off temperature for a catalytic converter associated with the engine.

16. The method of claim 14 wherein the temperature associated with the engine is a cylinder head temperature.

17. The method of claim 14 wherein the temperature associated with the engine is an engine coolant temperature.
